(19) United States
(12) Patent Application Publication
(10) Pub. No.: US 2026/0249950 A1
(43) Pub. Date: Aug. 27, 2026

(54) Drive Train for a Bicycle

(71) Applicant: ZF Friedrichshafen AG, Friedrichshafen (DE)

(72) Inventors: Philipp RECHENBACH, Markdorf (DE); Fabian KUTTER, Kressbronn (DE); Johannes KALTENBACH, Friedrichshafen (DE); Joachim ZANKER, Oggelshausen (DE); Leonhard BOSEN, Aachen (DE); Uwe GRIESMEIER, Markdorf (DE); Andreas ZIBOLD, Meissenheim (DE); Eckhardt LÜBKE, Friedrichshafen (DE)

(21) Appl. No.: 19/159,205

(22) PCT Filed: Feb. 22, 2024
(86) PCT No.: PCT/EP2024/054469

§ 371 Date: Aug. 22, 2025

(30) Foreign Application Priority Data
Feb. 23, 2023 (DE) 10 2023 201 654.0

(51) Int. Cl. B62M 11/14; B62M 6/55; F16D 41/24

(52) U.S. Cl. CPC B62M 11/145; B62M 6/55; F16D 41/24

(57) ABSTRACT

A drive train, which is designed for a continuously variable transmission ratio between a pedal crankshaft (10) and a driven shaft (12), includes three planetary gear sets (20, 30, 40). A first motor shaft (W1) is permanently connected to a first sun gear (22) for conjoint rotation. A first planet carrier (24) is permanently connected to a second ring gear (36) for conjoint rotation. The first planet carrier (24) is connectable to a third sun gear (42) for conjoint rotation. A first ring gear (26) is permanently connected to a second sun gear (32) for conjoint rotation. A third planet carrier (44) is connectable to the pedal crankshaft (10) for conjoint rotation. A third ring gear (46) is connectable to the driven shaft (12) for conjoint rotation. The second planetary gear set (30) is nested radially outwards with the first planetary gear set (20).

### CROSS-REFERENCE TO RELATED APPLICATIONS

The present application is related and has right of priority to DE102023201654.0 filed on Feb. 23, 2023 in the German Patent Office and is a U.S. National Phase of PCT/EP 2024/054469 filed on Feb. 22, 2024 in the European Patent Office, both of which are incorporated by reference in their entirities.

### TECHNICAL FIELD

The present invention relates generally to a drive train for a bicycle.

### BACKGROUND

In bicycles, a gear shift mechanism is an important component for enabling comfortable riding with different gears. The more precisely a transmission ratio in a drive train of the bicycle can be adapted to a current ground speed, the better a rider can pedal at a crank speed that is comfortable. A complex gearing that requires a large amount of installation space is usually necessary, however, for an appropriate adaptability of the transmission ratio. When the gearing is arranged in a bicycle frame, however, the installation space is very limited. A high overall gear ratio is also desirable, in order to be able to easily manage steep gradients yet still be able to reach high ground speeds.

Modern bicycles are also frequently designed with electrical propulsion force assistance. Such bicycles are also known as pedelecs. As a result, for example, persons who are not very fit can also comfortably use a bicycle. It is also desirable that a transmission ratio be adaptable when using electric machines for propulsion force assistance, so that the electrical propulsion force assistance can be efficiently operated.

DE 10 2015 208 355 A1 describes a vehicle with a gearing in a planetary design, wherein the gearing is to be particularly suitable for electric vehicles due to the configuration.

### SUMMARY

A first example aspect relates to a drive train for a bicycle. A bicycle can be designed, for example, as a vehicle operated by muscle power or as a pedelec. At least a portion of a propulsive force can be provided, for example, by a rider. A bicycle has, for example, a bicycle frame and at least two wheels rotatably mounted thereon. The drive train can be designed to provide a propulsive force at at least one driven wheel of these wheels.

The drive train has a pedal crankshaft. Crank arms with pedals rotatably fastened thereon can be fastened on the pedal crankshaft. Via the pedals, a rider of the vehicle can apply muscle power onto the pedal crankshaft by, for example, their legs. Via the pedal crankshaft, muscle power can be introduced into the drive train. The pedal crankshaft can be designed, for example, as a central shaft which extends transversely through a bicycle frame. The pedal crankshaft and, optionally, also the entire drive train can be mounted at a bottom bracket region of the bicycle frame.

The drive train has a driven shaft. The driven shaft can be connected to a wheel of the vehicle via a force transmission element. For example, the driven shaft can be connected to a wheel of the vehicle via a chain or a belt. A sprocket, for example, can be permanently fastened to the driven shaft for conjoint rotation. The driven shaft can be arranged, for example, coaxially with the pedal crankshaft.

The drive train has a first electric machine with a first motor shaft. In addition to the first electric machine, the drive train can have further electric machines. Alternatively, the drive train can be free of additional electric machines. The first electric machine can be designed to provide drive power at the first motor shaft. The numbering as the first motor shaft can be used merely for association with the first electric machine. The first electric machine can also be free of further motor shafts. The first electric machine can change, for example, a transmission ratio from the pedal crankshaft to the driven shaft by rotating the first motor shaft. Alternatively or additionally, as a result, for example, a drive power can also be provided for the driven shaft.

An electric machine can be designed to convert electrical energy into mechanical energy. Alternatively or additionally, an electric machine can be designed for recuperation. An electric machine can be designed, for example, as an asynchronous motor or a synchronous motor. The drive train can have an energy storage device, for example, a rechargeable battery. Using the energy storage device, respective electric machines of the drive train can be supplied with electrical energy for operating same. Alternatively or additionally, during recuperation, electrical energy from respective electric machines can be fed to the energy storage device. The drive train can have an inverter as a control device, which can control a power transmission between the energy storage device and an electric machine in an open loop. The inverter can control an operation of an electric machine in an open loop. One inverter per electric machine can be provided. Alternatively, one inverter can be provided for multiple electric machines.

The drive train is designed to provide a continuously variable transmission ratio between a pedal crankshaft of the drive train and a driven shaft of the drive train. For example, as a result, a torque and, alternatively or additionally, a rotational speed can be transmitted from respective input shafts to the driven shaft with an adjustable gear ratio. The drive train can be designed, for example, to provide a continuously variable transmission ratio of a torque between the pedal crankshaft and the driven shaft. A continuously variable transmission ratio can mean that a gear ratio can be freely selected at least in a certain range of ratios. As a result, the transmission ratio can be adapted to a current riding situation particularly well, using few parts and with a low installation space requirement. In contrast thereto, with stepped gearing, for example, only discrete gear ratios can be selected. For many different transmission ratios, typically many parts are then required, including many that are designed as shift elements, with a correspondingly large installation space requirement.

The drive train has a gearing. The gearing can be designed to transmit torque from the pedal crankshaft to the driven shaft and, alternatively or additionally, from the first motor shaft to the driven shaft. The gearing can enable the continuously variable transmission ratio. The gearing can be free of actively engageable and disengageable clutches. The drive train can have, as shift elements, for example, only freewheel units. The transmission ratio is varied, for example, only in response to a change in rotational speed at the first motor shaft.

The gearing has a first planetary gear set with a first sun gear, a first planet carrier, and a first ring gear. The gearing has a second planetary gear set with a second sun gear, a second planet carrier, and a second ring gear. The gearing has a third planetary gear set with a third sun gear, a third planet carrier, and a third ring gear. The gearing can be, for example, free of further planetary gear sets. The numbering of the rotary elements can be used merely to associate these with the respective planetary gear set. The second planetary gear set can be, for example, free of further rotary elements, for example, a further sun gear or a further ring gear.

A planetary gear set can be designed, for example, as a negative planetary gear set or as a positive planetary gear set. A planetary gear set can have three rotary elements, a sun gear, a planet carrier, and a ring gear. One or more planet gears can be rotatably mounted on a planet carrier of a planetary gear set. For example, a planetary gear set can have three planet gears arranged about the pedal crankshaft on the same diameter. A sun gear can have an external toothing, with which respective planet gears mesh. A ring gear can have an internal toothing, with which respective planet gears mesh. In a negative planetary gear set, the planet gears mesh, for example, both with the sun gear and with the ring gear. A negative planetary gear set has a negative fixed carrier train ratio. Alternatively, a planetary gear set can be designed as a positive planetary gear set. A positive planetary gear set has a positive fixed carrier train ratio. In a positive planetary gear set, for example, multiple sets of planet gears are provided. In the case of two sets of planet gears, each planet gear of a first set meshes with a sun gear and a planet gear of a second set. The planet gears of the second set mesh in this case with the planet gears of the first set and with a ring gear.

The first motor shaft is permanently connected to the first sun gear for conjoint rotation. The first sun gear can form an input shaft of the gearing, at which a transmission ratio of the gearing is adjustable by the first electric machine. The first planet carrier is permanently connected to the second ring gear for conjoint rotation. The first planet carrier is connectable to the third sun gear for conjoint rotation, for example, by a freewheel unit. The first planet carrier can also be permanently connected to the third sun gear for conjoint rotation. The first ring gear is permanently connected to the second sun gear for conjoint rotation. The third planet carrier is connectable to the pedal crankshaft for conjoint rotation, for example, by a freewheel unit. The third planet carrier can also be permanently connected to the pedal crankshaft for conjoint rotation. The third planet carrier can therefore form an input shaft of the gearing for introducing muscle power. The third ring gear is connectable to the driven shaft for conjoint rotation, for example, by a freewheel unit. The third ring gear can also be permanently connected to the driven shaft for conjoint rotation. The third ring gear can form an output shaft of the gearing, at which a converted variable is provided for the driven shaft. This yields a gearing with a compact design, a continuously variable transmission ratio with a large spread of gear ratios, and few parts. The gearing can thus also be free of shift elements that are to be actively actuated.

If two elements are mechanically operatively connected, these elements can be directly or indirectly coupled to each other such that a movement of one element can induce a response by the other element. For example, a mechanical operative connection can be provided by an interlocking connection or a frictional connection. A mechanical operative connectability can be establishable and also disconnectable by a freewheel unit or another shift element. A mechanical operative connection can remain permanently. For example, the mechanical operative connection can correspond to an intermeshing of corresponding toothings of two elements. Further elements can be provided between mechanically operatively interconnected elements.

A permanently corotational connection of two elements should be understood as a connection in which the two elements are substantially rigidly coupled to each other in all proper states. These also include a frictional connection, in which desirable slip or undesirable slip can occur. Elements that are permanently rotationally fixed to each other can be present, for example, as individual components that are rotationally fixed to each other, or also as single pieces.

A connection of two elements via a further element can mean that this further element can contribute to an indirect operative connection of the two elements. For example, this element can be arranged in power flow between these two elements. A connection of two elements via two or more elements can mean that these further elements all contribute to an indirect operative connection of the two elements. An engaging and disengaging connection can, in one state, enable a torque transmission between two elements, for example, by a rigid coupling, and, in another state, substantially interrupt this torque transmission. To this end, a corresponding shift element can be provided between the two elements.

The drive train can be free of elements other than those mentioned here. For example, the drive train can have no further rotary elements, shift elements, planetary gear sets and, alternatively or additionally, electric machines.

The second planetary gear set is nested radially outwards with the first planetary gear set. The second planetary gear set can be arranged radially external to the first planetary gear set. Therefore, at least one rotary element of the first planetary gear set can be arranged at least partially in the same axial region as a rotary element of the second planetary gear set. For example, at least the first ring gear and the second sun gear can be arranged at least partially in the same axial region. An axial region can correspond, for example, to an extent along the pedal crankshaft. All rotary elements of the second planetary gear set can be arranged radially external to all rotary elements of the first planetary gear set due to the radially external nesting with the first planetary gear set. For example, due to the radially external nesting, all rotary elements of the second planetary gear set can each have an effective diameter that is greater in each case than all effective diameters of all rotary elements of the first planetary gear set. For example, an effective diameter of an internal toothing of the first ring gear can be smaller than an effective diameter of an external toothing of the second sun gear. Due to the radial nesting, the gearing can be axially highly compact, such that a high continuously variable transmission ratio can be implemented even in a limited installation space of a bicycle frame. Due to the radial nesting, the planet gears of the first planetary gear set and the planet gears of the second planetary gear set can be relatively small and the toothings thereof can have a comparatively small module, for example, due to small teeth. Such a design is possible nevertheless without overloading the gearing, since a high torque possibly introduced by the rider at the pedal crankshaft is greatly reduced by the third planetary gear set. As a result, a load on the first planetary gear set and on the second planetary gear set can be low.

The planet gears of the first planetary gear set and the planet gears of the second planetary gear set can have an effective diameter of substantially the same size. To this end, a corresponding fixed carrier train ratio of the first planetary gear set and a corresponding fixed carrier train ratio of the second planetary gear set can be selected. As a result, the situation can be avoided, in which, due to a large effective diameter of the planet gears of one of these two planetary gear sets, an effective diameter of the planet gears of the other of these two planetary gear sets must be small due to a radial limitation of installation space. Such a limitation of installation space can make it necessary to have very small planetary bearings. Without this installation space limitation, larger planetary bearings can be used, as a result of which a service life of the bearings can be high.

In one example embodiment of the drive train, according to example aspects of the invention, the first ring gear and the second sun gear are formed by a common component. As a result, the drive train can be highly compact, robust, and cost-effective. For example, this component can be formed in one piece with an external toothing and an internal toothing. For example, this component can also be formed from multiple parts. Due to the design as a common component, a separate mounting of the first ring gear and the second sun gear can be dispensed with. Instead, these can be, for example, mounted together.

In one example embodiment of the drive train, according to example aspects of the invention, the second planet carrier is rotationally fixed. A rotationally fixed component is, for example, not rotatable. For example, the second planet carrier can be permanently connected to a stationary component, such as a housing of the gearing, in a rotationally fixed manner. The housing can be formed, for example, by the bicycle frame or permanently connected thereto in a rotationally fixed manner. This design makes a high maximum speed possible. In addition, in most use cases, such as a ground speed that is not only very low, a rolling power can be low and the efficiency can be high. The second planet carrier can be permanently connected to the housing in a rotationally fixed manner, for example, axially on the motor side. Then, the connection between the first planet carrier and the second ring gear can be arranged, for example, axially on the driven side of the first planetary gear set and the second planetary gear set. The second planet carrier can be permanently connected to the housing in a rotationally fixed manner, for example, axially on the driven side. Then, the connection between the first planet carrier and the second ring gear can be arranged, for example, axially on the motor side of the first planetary gear set and the second planetary gear set. The motor side can be a side facing the first electric machine. The driven side can be a side facing the driven shaft.

In one example embodiment of the drive train, according to example aspects of the invention, the second planet carrier is permanently connected to the third ring gear for conjoint rotation. As a result, a bearing base for the driven shaft and, alternatively or additionally, the third ring gear can be particularly wide. Thus, particularly high loads can be safely supported there. In this design, the connection between the first planet carrier and the second ring gear is arranged, for example, axially on the motor side of the first planetary gear set and the second planetary gear set.

In one example embodiment of the drive train, according to example aspects of the invention, the drive train has a second electric machine with a second motor shaft. The numbering of the second motor shaft can be used again for association with the second electric machine, which can be free of further motor shafts. The drive train can have a connecting gearing with an input shaft and with an output shaft. The connecting gearing can be a gearing that connects the second motor shaft to the above-described gearing with a fixed or also variable transmission ratio. The connecting gearing can be, for example, free of shift elements. The connecting gearing can provide a mechanical operative connection between its input shaft and output shaft. The second motor shaft can be permanently connected to the input shaft for conjoint rotation. The output shaft can be mechanically operatively connected to the driven shaft or permanently connected thereto for conjoint rotation. Due to the second electric machine, the rider can be particularly efficiently assisted during propulsion of the bicycle, for example, by an input-side or output-side introduction of a motorized drive force from the second electric machine. The second electric machine can also be efficiently driven while acting as a generator. The connecting gearing can facilitate a favorable arrangement of the second electric machine. The second electric machine can be arranged, for example, at least partially in the same axial region as the first electric machine. The second electric machine can be arranged radially external to the first electric machine. The first motor shaft and the second motor shaft can be arranged in parallel to and offset from one another. The first motor shaft and the pedal crankshaft can be coaxial.

In one example embodiment of the drive train, according to example aspects of the invention, the output shaft is connectable to the driven shaft for conjoint rotation. For example, the output shaft can be permanently connected to the driven shaft for conjoint rotation or even formed by the driven shaft or the third ring gear. The second electric machine can thus be connected on the driven side. A design can result, in which a mounting of the third ring gear and, alternatively or additionally, of the driven shaft is particularly simple.

In one example embodiment of the drive train, according to example aspects of the invention, the output shaft is connectable to the third planet carrier for conjoint rotation. For example, the output shaft can be permanently connected to the third planet carrier for conjoint rotation or even formed by the third planet carrier. The second electric machine can thus be connected on the drive side. A design can result, in which a particularly high support torque is possible when riding off from a standstill. In addition, a drive force of the second electric machine can be converted together with the muscle power of the rider at the pedal crankshaft.

In one example embodiment of the drive train, according to example aspects of the invention, the connecting gearing has a fourth planetary gear set with a fourth sun gear, a fourth planet carrier, and a fourth ring gear. The numbering as the fourth planetary gear set can be used for the association within the drive train. The connecting gearing can be, for example, free of further planetary gear sets other than the fourth planetary gear set. The connecting gearing can also have further planetary gear sets or even provide different transmission ratios in an engageable and disengageable manner. The connecting gearing can also have a transmission gearing. By the planetary gear set, the connecting gearing can have a high transmission ratio with a low installation space requirement. Due to the transmission gearing, an axial offset of the second electric machine with respect to the rest of the drive train can be easily bridged.

The fourth sun gear can be permanently connected to the second motor shaft for conjoint rotation. The fourth sun gear can form an input of the connecting gearing and of the planetary gear set. The fourth planet carrier can be mechanically operatively connected to the output shaft of the connecting gearing via the transmission gearing. The fourth planet carrier can form an output of the planetary gear set. The fourth ring gear can be rotationally fixed, for example, at the stationary component. The connecting gearing can thus be cost-effective, compact, and efficient. The fourth planetary gear set can be arranged coaxially with the second electric machine. The transmission gearing can be designed as a spur gear drive, for example, having two spur gear stages. The transmission gearing can have, for example, three spur gears meshing with one another in pairs. The transmission gearing can, alternatively or additionally, have, for example, a chain drive for the transmission. A chain drive can be, for example, quieter than a transmission gearing having spur gear stages. In addition, a bearing load at the third ring gear and, alternatively or additionally, the driven shaft, can be low. When spur gears are used for the transmission gearing, a weight can be low and the drive train can be cost-effective.

In one example embodiment of the drive train, according to example aspects of the invention, the drive train has a first freewheel unit. A freewheel unit can be designed, for example, as a pawl freewheel unit or a roller freewheel unit. Via a freewheel unit, two elements connected to the freewheel unit can be connected to each other for conjoint rotation when the freewheel unit is in a blocking state. In a release state, the two elements connected to the freewheel unit can be decoupled from each other. The freewheel unit can, for example, automatically switch between the blocking state and the release state depending on a relative direction of rotation of the two elements connected to the freewheel unit. In the release state, a significant transmission of torque or rotational speed between the elements that are connectable via the freewheel unit cannot take place. In the blocking state, torque and rotational speed can be transmitted between the elements that are connected via the freewheel unit. Due to an initial relative rotation of the two elements in a first relative direction of rotation, a freewheel unit can connect the two elements to each other for conjoint rotation, so that the blocking state can thus be achieved. If the blocking state has been reached, a relative rotation between the two elements cannot take place in the first relative direction of rotation. In a second relative direction of rotation counter thereto, these two elements can be decoupled from one another by the freewheel unit. Therefore, the freewheel unit can be transferred from the blocking state into the release state.

The pedal crankshaft can be mechanically operatively connectable to the driven shaft by the first freewheel unit. As a result, the pedal crankshaft can be decoupled from the driven shaft. Therefore, the situation can be avoided, in which the pedal crankshaft is driven due to inertias of respective electric machines when the rider suddenly stops pedaling. Thus, the use of the drive train can be particularly comfortable. The decoupling by the first freewheel unit can make sense specifically in response to high inertia and a possible high rotational speed—caused by the gearing—of the first electric machine and optional further electric machines, such as the second electric machine, in the drive train.

In one example embodiment of the drive train, according to example aspects of the invention, the pedal crankshaft is connectable to the third planet carrier for conjoint rotation by the first freewheel unit. Therefore, only the pedal crankshaft can be directly decoupled. Therefore, the inertia of the first electric machine and, optionally, also of the second electric machine, if present, can be decoupled, for example, from the pedal crankshaft. In this design, the third ring gear can be permanently connected to the driven shaft for conjoint rotation and the first planet carrier can be permanently connected to the third sun gear for conjoint rotation. In this design, integration of the freewheel unit is particularly simple. In addition, the drive train can thus be axially particularly compact. In addition, in the disengaged state, a differential speed at the first freewheel unit can be particularly low.

Alternatively, instead of the first freewheel unit, a permanent connection of the third planet carrier with the pedal crankshaft for conjoint rotation can also be provided.

In one example embodiment of the drive train, according to example aspects of the invention, the third ring gear is connectable to the driven shaft for conjoint rotation by the first freewheel unit. As a result, the driven shaft can be decoupled from the entire rest of the drive train. In this design, the pedal crankshaft can be permanently connected to the third planet carrier for conjoint rotation and the first planet carrier can be permanently connected to the third sun gear for conjoint rotation. Alternatively, instead of the first freewheel unit, a permanent connection of the third ring gear with the driven shaft for conjoint rotation can also be provided.

In one example embodiment of the drive train, according to example aspects of the invention, the first planet carrier is connectable to the third sun gear for conjoint rotation by the first freewheel unit. As a result, a transmission of torque from the pedal crankshaft to the driven shaft can also be interrupted due to an interruption of torque transmission at the third planetary gear set. In this design, the first freewheel unit, when in the blocking state, must transmit, for example, a particularly low torque. As a result, the first freewheel unit can be particularly small and lightweight. In this design, the pedal crankshaft can be permanently connected to the third planet carrier for conjoint rotation and the third ring gear can be permanently connected to the driven shaft for conjoint rotation. Alternatively, instead of the first freewheel unit, the first planet carrier can be permanently connected to the third sun gear for conjoint rotation.

In one example embodiment of the drive train, according to example aspects of the invention, the drive train has a second freewheel unit. The second freewheel unit can be designed to block a rotation of the first motor shaft in one direction of rotation. For example, the second freewheel unit can release a rotation of the motor shaft only in a direction of rotation that is used to reduce a transmission ratio of the gearing. Thus, high loads can be safely supported, for example, when a full weight force of the rider acts on a pedal. For example, a start-up torque applied by the rider can thus also be supported, which the first electric machine cannot support. In addition, it is thus easy to start riding the bicycle also in the event of a failure of a power supply of the first electric machine. If a second freewheel unit is not provided, a comparatively high transmission ratio for starting off particularly easily can be provided.

In one example embodiment of the drive train, according to example aspects of the invention, the first motor shaft is rotationally fixable, for example, at the stationary component, by the second freewheel unit. As a result, a particularly low torque can act on the second freewheel unit, since the pedaling force on the pedal crankshaft is converted in advance by the gearing.

In one example embodiment of the drive train, according to example aspects of the invention, a rotary element of the first planetary gear set is rotationally fixable by the second freewheel unit. For example, the first planet carrier can be rotationally fixable by the second freewheel unit. Alternatively, for example, the first ring gear is rotationally fixable by the second freewheel unit. In these designs, for example, the second planet carrier is rotationally fixed. The second freewheel unit can thus be easily integrated.

A second example aspect relates to a bicycle. The bicycle drive can be designed, for example, as a pedelec. The bicycle can have a drive train according to the first example aspect. Respective features and advantages of the first example aspect are correspondingly similar features and advantages of the second example aspect, and vice versa. The bicycle can have a bicycle frame and at least one wheel. The driven shaft of the drive train can be mechanically operatively connectable to the at least one wheel of the bicycle, for example, by a chain or a belt. The wheel can thus be a driven wheel. The wheel can have, for example, a rim and a casing. The wheel can also have a hub. The hub can have a further freewheel unit.

### BRIEF DESCRIPTION OF THE FIGURES

FIG. 1 schematically shows a first example embodiment of a drive train of a bicycle.

FIG. 2 schematically shows a second example embodiment of the drive train.

FIG. 3 schematically shows a third example embodiment of the drive train.

FIG. 4 schematically shows a fourth example embodiment of the drive train.

FIG. 5 schematically shows a fifth example embodiment of the drive train.

FIG. 6 schematically shows a sixth example embodiment of the drive train.

FIG. 7 schematically shows a seventh example embodiment of the drive train.

FIG. 8 schematically shows an eighth example embodiment of the drive train.

FIG. 9 schematically shows a ninth example embodiment of the drive train.

FIG. 10 schematically shows a tenth example embodiment of the drive train.

FIG. 11 schematically shows an eleventh example embodiment of the drive train.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

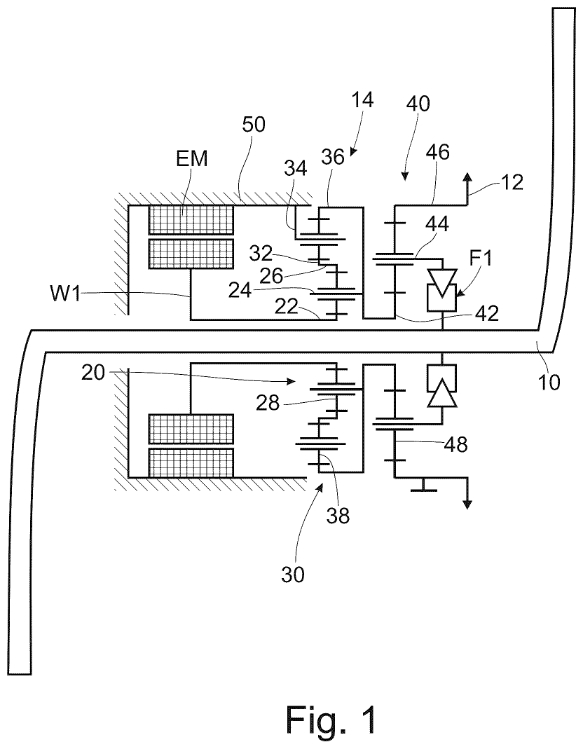

FIG. 1 schematically shows a first example embodiment of a drive train for a bicycle with a pedal crankshaft 10, a driven shaft 12, a gearing 14, and a first electric machine EM1 with a first motor shaft W1. The drive train is designed for a continuously variable transmission ratio between the pedal crankshaft 10 and the driven shaft 12. The pedal crankshaft 10 defines an axial direction and extends as a central shaft through the gearing 14. The first motor shaft W1 is arranged coaxially with the pedal crankshaft 10.

The gearing 14 has a first planetary gear set 20 with a first sun gear 22, a first planet carrier 24, and a first ring gear 26. A set of first planet gears 28 is rotatably mounted on the first planet carrier 24, which planet gears each mesh with the first sun gear 22 and the first ring gear 26. The gearing 14 has a second planetary gear set 30 with a second sun gear 32, a second planet carrier 34, and a second ring gear 36. A set of second planet gears 38 is rotatably mounted on the second planet carrier 34, which planet gears each mesh with the second sun gear 32 and the second ring gear 36. The gearing 14 has a third planetary gear set 40 with a third sun gear 42, a third planet carrier 44, and a third ring gear 46. A set of third planet gears 48, each of which meshes with the third sun gear 42 and with the third ring gear 46, is rotatably mounted on the third planet carrier 44. By the first electric machine EM1, a transmission ratio from the pedal crankshaft 10 via the third planetary gear set 40 to the driven shaft 12 can be changed in a continuously variable manner.

The second planetary gear set 30 is nested radially outwards with the first planetary gear set 20. All effective diameters of the rotary elements of the second planetary gear set 30 are larger than all effective diameters of the rotary elements of the first planetary gear set 20. On the other hand, the effective diameters of the planet gears 38 of the second planetary gear set 30 are smaller, equal to, or larger—depending on the design—than respective effective diameters of the planet gears 28 of the first planetary gear set 20. In addition, the second planetary gear set 30 is arranged at least partially axially in the same region as the first planetary gear set 20. The drive train is thus axially particularly compact. The third planetary gear set 40 is arranged axially next to the first planetary gear set 20 and the second planetary gear set 30. In the example shown, the third planetary gear set 40 extends radially in overlap with the second planetary gear set 30 and the first planetary gear set 20. The three planetary gear sets 20, 30, 40 are arranged coaxially with the pedal crankshaft 10.

The first motor shaft W1 is permanently connected to the first sun gear 22 for conjoint rotation. The first planet carrier 24 is permanently connected to the second ring gear 36 for conjoint rotation. The first planet carrier 24 is connectable to the third sun gear 42 for conjoint rotation. The first ring gear 26 is permanently connected to the second sun gear 32 for conjoint rotation. The first ring gear 26 and the second sun gear 32 are formed as a common component, which, in the example shown, is designed as a one-piece element with internal toothing and external toothing. The third planet carrier 44 is connectable to the pedal crankshaft 10 for conjoint rotation. The third ring gear 46 is connectable to the driven shaft 12 for conjoint rotation.

The pedal crankshaft 10 is mechanically operatively connectable to the driven shaft 12 by an optional first freewheel unit F1. In the first example embodiment, the third planet carrier 44 is connectable to the pedal crankshaft 10 for conjoint rotation by the first freewheel unit F1. In the first example embodiment, the first planet carrier 24 and the third sun gear 42 are permanently connected to each other for conjoint rotation. The third ring gear 46 in the first example embodiment is permanently connected to the driven shaft 12 for conjoint rotation. The second planet carrier 34 is permanently connected in a rotationally fixed manner to a stationary component 50 in the form of a housing and, thus, is rotationally fixed. The connection between the stationary component 50 and the second planet carrier 34 is arranged axially on the motor side of the first planetary gear set 20 and the second planetary gear set 30. The connection between the first planet carrier 24 and the second ring gear 36 is arranged axially on the driven side of the first planetary gear set 20 and the second planetary gear set 30.

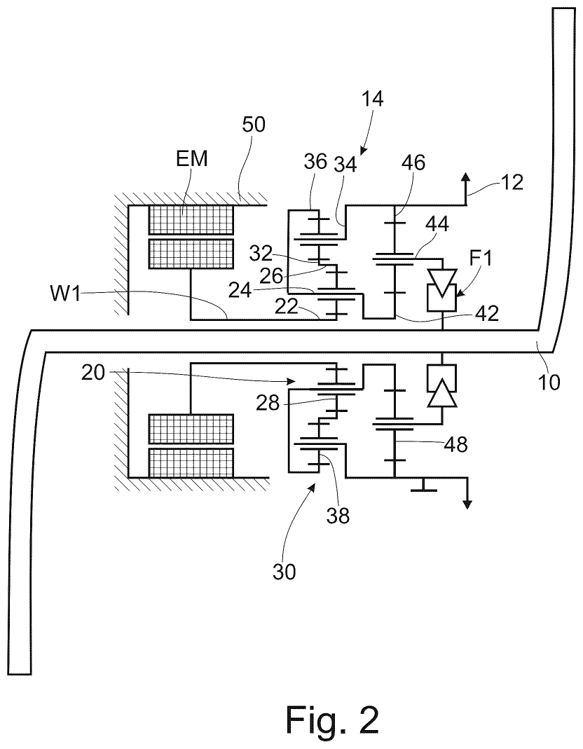

FIG. 2 shows a second example embodiment of the drive train, which is designed similarly to the first example embodiment. In the following, only differences from the first example embodiment will be discussed.

In the second example embodiment, the second planet carrier 34 is permanently connected to the third ring gear 46 for conjoint rotation, instead of being rotationally fixed. Correspondingly, the connection between the first planet carrier 24 and the second ring gear 36 is therefore now arranged axially on the motor side of the first planetary gear set 20 and the second planetary gear set 30. This configuration of the gearing 14 and of the aforementioned connections can also be provided in the rest of the example embodiments, which are configured similarly to the first example embodiment with respect to these parts and connections.

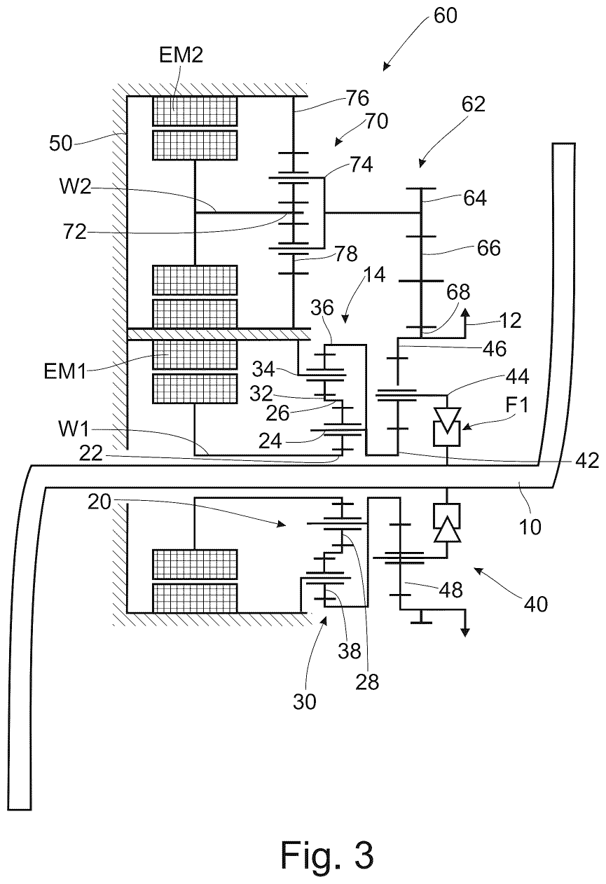

FIG. 3 shows a third example embodiment of the drive train, which additionally has a second electric machine EM2 with a second motor shaft W2 and a connecting gearing 60 with an input shaft and an output shaft and is otherwise designed identically to the first example embodiment. The second motor shaft W2 is permanently connected to the input shaft for conjoint rotation. The output shaft is mechanically operatively connected to the driven shaft 12.

For this connection, the connecting gearing 60 has a fourth planetary gear set 70 with a fourth sun gear 72, a fourth planet carrier 74, and a fourth ring gear 76, as well as a transmission gearing 62. A set of fourth planet gears 78, each of which meshes with the fourth sun gear 72 and the fourth ring gear 76, is rotatably mounted on the fourth planet carrier 74. The fourth sun gear 72 is permanently connected to the second motor shaft W2 for conjoint rotation and thus forms the input shaft of the connecting gearing 60. The fourth ring gear 76 is permanently connected to the stationary component 50 in a rotationally fixed manner and, thus, is rotationally fixed. The transmission gearing 62 has three spur gears 64, 66, and 68 meshing with each other in pairs. A spur gear 64 closest on the motor side in the torque flow is permanently connected to the fourth planet carrier 74 for conjoint rotation. A spur gear 68 closest on the driven side in the torque flow is permanently connected to the driven shaft 12 for conjoint rotation or is formed by same. This spur gear 68 closest on the driven side therefore forms the output shaft of the connecting gearing 60.

This yields a point of connection of the second electric machine EM2 on the driven side in the torque flow, which second electric machine can therefore directly drive the driven shaft 12. The two motor shafts W1, W2 are axially parallel to and offset from each other. The transmission gearing 62 bridges an axial offset. Alternatively or additionally, the transmission gearing 62 provides, depending on the selected design and effective diameters of spur gears or sprockets, a transmission ratio between the fourth planet carrier 74 and the driven shaft 12. The fourth planetary gear set 70 provides a high ratio for the second electric machine EM2 in a compact manner.

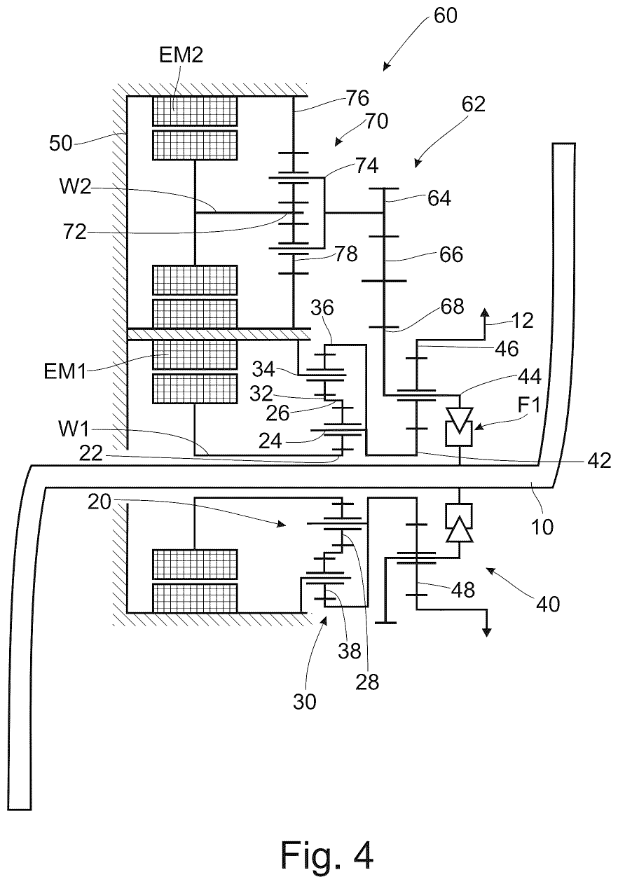

FIG. 4 shows a fourth example embodiment of the drive train, which is designed similarly to the third example embodiment. In the following, only differences from the third example embodiment will be discussed.

In the fourth example embodiment, the second electric machine EM2 is connected differently to the rest of the drive train. The output shaft of the connecting gearing 60, which is again formed by the spur gear 68 of the transmission gearing 62, which spur gear is closest on the driven side, is connectable to the third planet carrier 44 for conjoint rotation or is formed by the third planet carrier 44. In the fourth example embodiment, the output shaft in the example shown is permanently connected to the third planet carrier 44 for conjoint rotation. The second electric machine EM2 is therefore connected to the gearing 14 on the drive side. Therefore, a drive force provided by the second electric machine EM2 can be transmitted to the driven shaft 12 with the transmission ratio that is continuously variable by the first electric machine EM1. The transmission gearing 62 in the fourth example embodiment is arranged axially on the motor side of the third planetary gear set 40, instead of in the axially identical region or axially on the driven side thereof as in the third example embodiment.

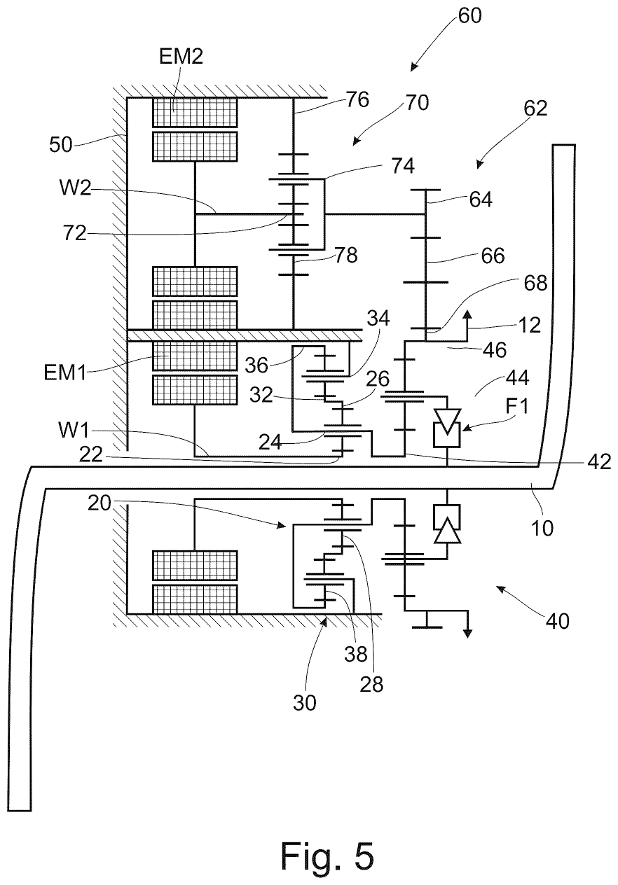

FIG. 5 shows a fifth example embodiment of the drive train, which is designed similarly to the third example embodiment. In the following, only differences from the third example embodiment will be discussed.

In the fifth example embodiment, in contrast to the first and the third example embodiments, the second planet carrier 34 is connected to the stationary component 50 axially on the driven side and, thus, between the first planetary gear set 20, or the second planetary gear set 30, and the third planetary gear set 40. The connection of the second ring gear 36 to the first planet carrier 24 is arranged axially on the motor side and between the first electric machine EM1 and the first planetary gear set 20, or the second planetary gear set 30.

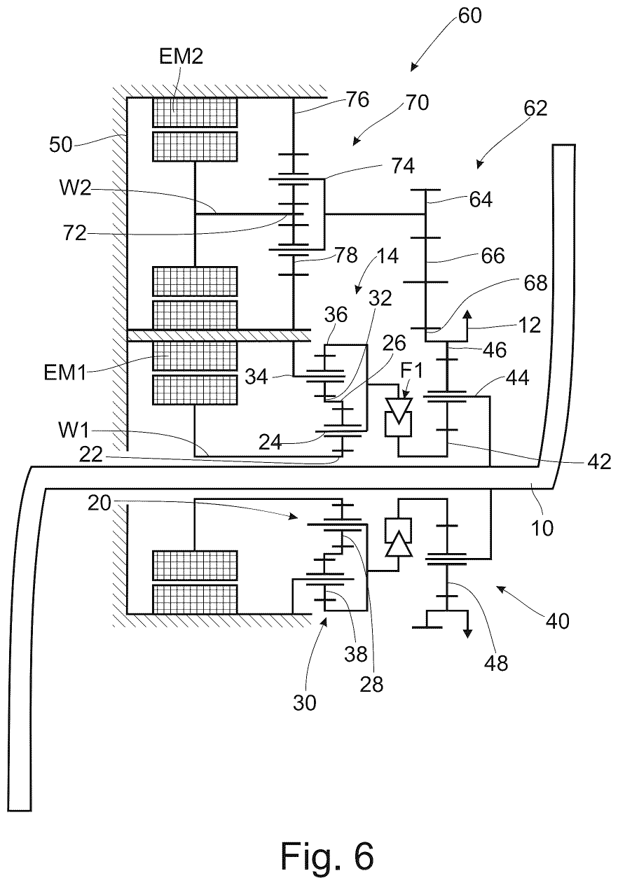

FIG. 6 shows a sixth example embodiment of the drive train, which is designed similarly to the third example embodiment. In the following, only differences from the third example embodiment will be discussed.

In the sixth example embodiment, the first freewheel unit F1 is arranged differently. The first planet carrier 24 is connectable to the third sun gear 42 for conjoint rotation by the first freewheel unit F1. Therefore, a permanent connection for conjoint rotation is not provided between the first planet carrier 24 and the third sun gear 42. However, the pedal crankshaft 10 and the third planet carrier 44 are now permanently connected to each other for conjoint rotation. In addition, the third planetary gear set 40 is now positioned, in comparison to the third example embodiment, axially closer driven-side relative to the transmission gearing 62.

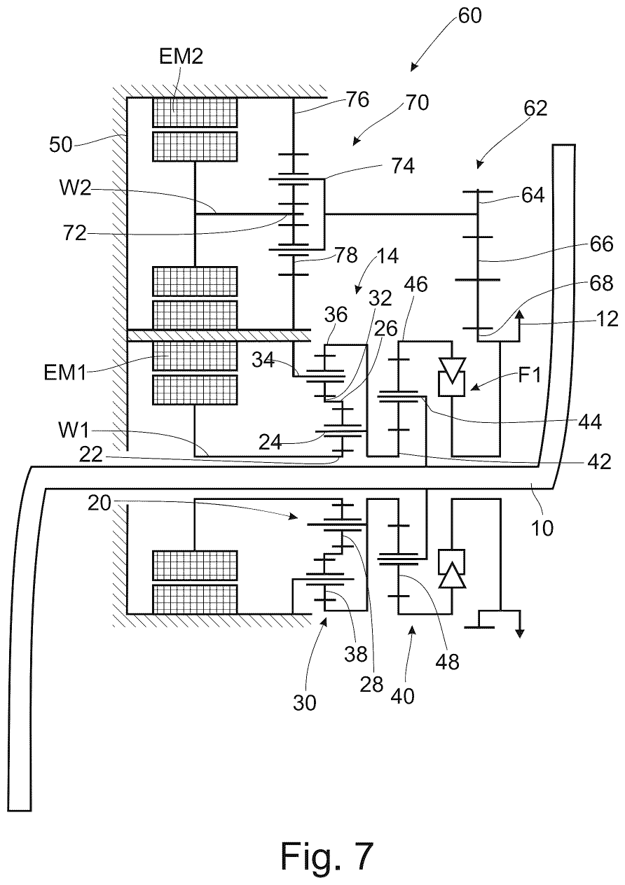

FIG. 7 shows a seventh example embodiment of the drive train, which is designed similarly to the third example embodiment. In the following, only differences from the third example embodiment will be discussed.

In the seventh example embodiment, the first freewheel unit F1 is arranged differently than in the third and sixth example embodiments. The third ring gear 46 is connectable to the driven shaft 12 for conjoint rotation by the first freewheel unit F1. A permanent connection for conjoint rotation is therefore not provided between the third ring gear 46 and the driven shaft 12. However, the pedal crankshaft 10 and the third planet carrier 44 are now permanently connected to each other for conjoint rotation. In contrast to the sixth example embodiment, the first planet carrier 24 and the third sun gear 42 are also again permanently connected to each other for conjoint rotation. In addition, the third planetary gear set 40 is now positioned, in comparison to the third example embodiment, axially closer motor-side relative to the transmission gearing 62. The first freewheel unit F1 is therefore arranged axially between the third planetary gear set 40 and the transmission gearing 62.

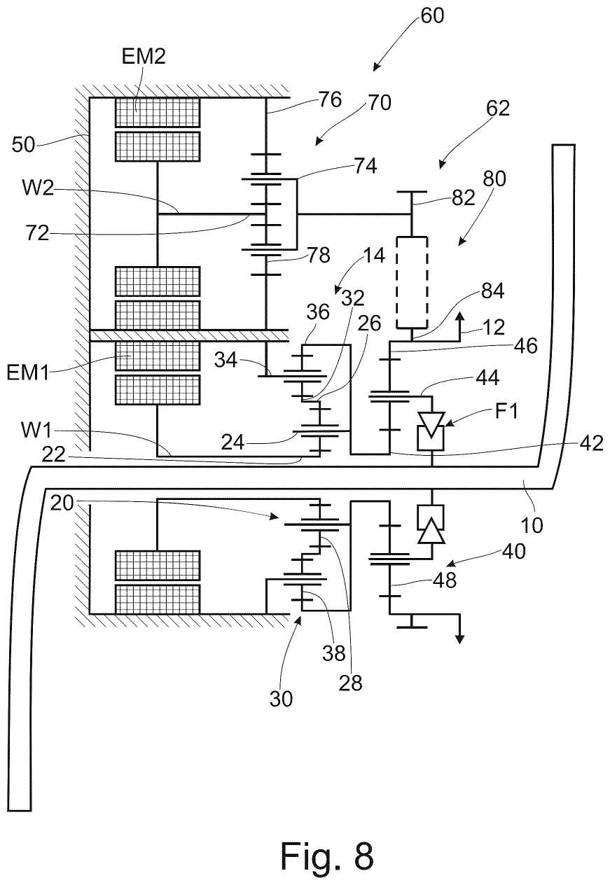

FIG. 8 shows an eighth example embodiment of the drive train, which is designed similarly to the third example embodiment. In the following, only differences from the third example embodiment will be discussed.

In the eighth example embodiment, the transmission gearing 62 of the connecting gearing 60 is designed differently. Instead of three spur gear stages, one chain drive 80 is now provided. A first sprocket 82 of this chain drive 80 is arranged on the motor side in the torque flow and is permanently connected to the fourth planet carrier 74 for conjoint rotation. A second sprocket 84 of this chain drive 80 is arranged on the driven side in the torque flow and forms the output shaft of the connecting gearing 60. The second sprocket 84 is permanently connected to the driven shaft 12 for conjoint rotation or is formed by same.

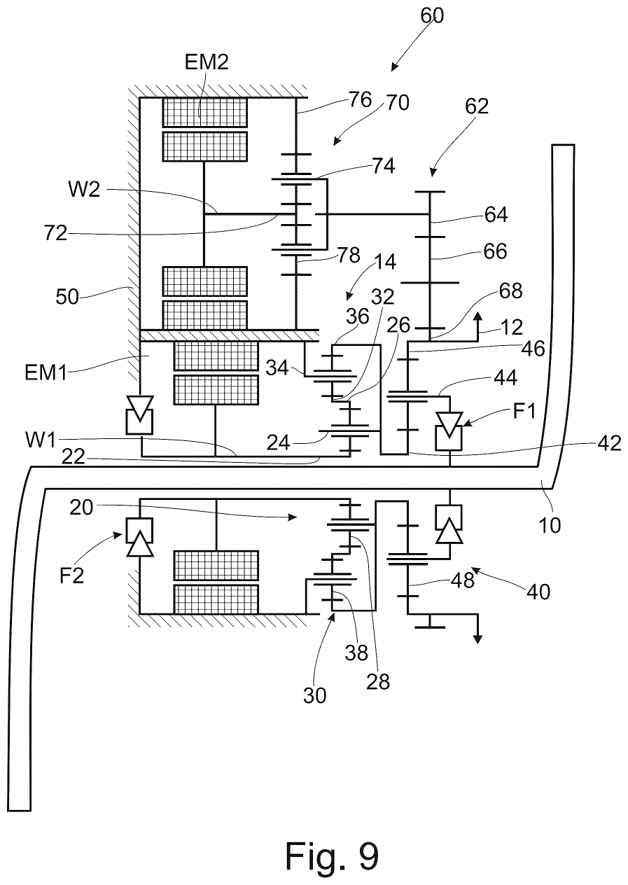

FIG. 9 shows a ninth example embodiment of the drive train, which additionally has a second freewheel unit F2 and is otherwise designed identically to the third example embodiment. The second freewheel unit F2 is designed to block a rotation of the first motor shaft W1 in one direction of rotation. In an opposite direction of rotation, the first motor shaft W1 is released and can rotate.

In the ninth example embodiment, the first motor shaft W1 is rotationally fixable by the second freewheel unit F2. In the blocking state, the second freewheel unit F2 connects the first motor shaft W1 to the stationary component 50 in a rotationally mixed manner for this purpose. The second freewheel unit F2 is arranged such that the first motor shaft W1 can be rotated by the first electric machine EM1 in only one direction of rotation, which increases the transmission ratio of the third planetary gear set 40 from the third planet carrier 44 to the third ring gear 46.

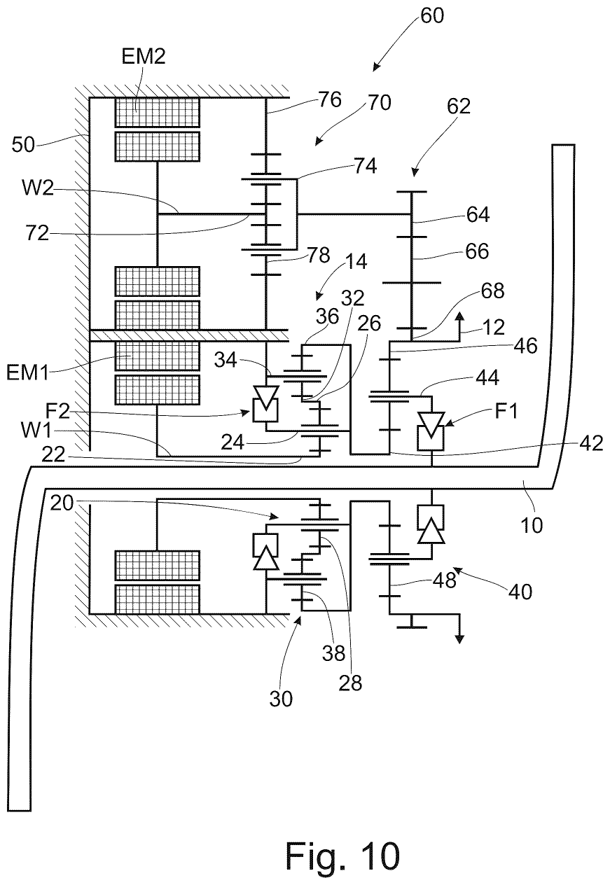

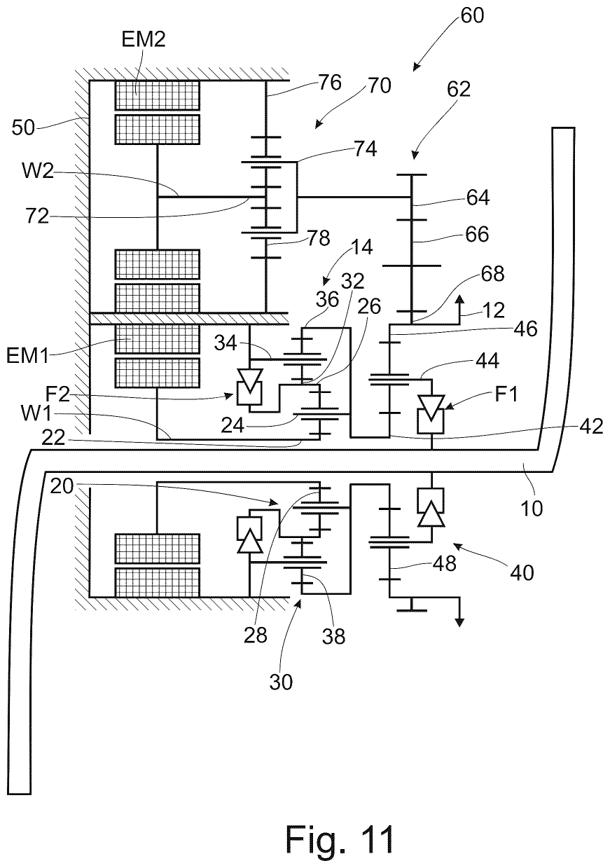

FIG. 10 shows a tenth example embodiment of the drive train and FIG. 11 shows an eleventh example embodiment of the drive train. In these two example embodiments, a rotary element is rotationally fixable by the first planetary gear set 20 by the second freewheel unit F2 in order to thus block rotation of the first motor shaft W1 in one direction of rotation as in the ninth example embodiment. In the tenth example embodiment, for this purpose, the first planet carrier 24 is connectable to the stationary component 50 in a rotationally fixed manner by the second freewheel unit F2 and, thus, is rotationally fixable. In the eleventh example embodiment, for this purpose, the first ring gear 26 is connectable to the stationary component 50 in a rotationally fixed manner by the second freewheel element F2 and, thus, is rotationally fixable. Otherwise, the tenth example embodiment and the eleventh example embodiment are designed identically to the ninth example embodiment.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 pedal crankshaft
12 driven shaft
14 gearing
20, 30, 40, 70 planetary gear set
22, 32, 42, 72 sun gear
24, 34, 44, 74 planet carrier
26, 36, 46, 76 ring gear
28, 38, 48, 78 planet gears
50 stationary component
60 connecting gearing
62 transmission gearing
64, 66, 68 spur gear
80 chain drive
82, 84 sprocket
EM1; EM2 electric machine
W1, W2 motor shaft
F1; F2 freewheel unit

1-15. (canceled)

16. A drive train for a bicycle, comprising:
a pedal crankshaft (10);
a driven shaft (12);
a gearing (14) comprising a first planetary gear set (20), a second sun gear (32), and a third planetary gear set (40), the first planetary gear set (20) comprising a first sun gear (22), a first planet carrier (24), and a first ring gear (26), the second planetary gear set (30) comprising a second sun gear (32), a second planet carrier (34), and a second ring gear (36), the third planetary gear set (40) comprising a third sun gear (42), a third planet carrier (44), and a third ring gear (46), the first planet carrier (24) permanently connected to the second ring gear (36) for conjoint rotation, the first planet carrier (24) connectable to the third sun gear (42) for conjoint rotation, the first ring gear (26) permanently connected to the second sun gear (32) for conjoint rotation, the third planet carrier (44) connectable to the pedal crankshaft (10) for conjoint rotation, the third ring gear (46) connectable to the driven shaft (12) for conjoint rotation, the second planetary gear set (30) nested radially outwards with the first planetary gear set (20); and
a first electric machine (EM1) with a first motor shaft (W1) that is permanently connected to the first sun gear (22) for conjoint rotation,
wherein the drive train is configured for providing a continuously variable transmission ratio between the pedal crankshaft (10) and the driven shaft (12).

17. The drive train of claim 16, wherein the first ring gear (26) and the second sun gear (32) are formed by a common component.

18. The drive train of claim 16, wherein the second planet carrier (34) is rotationally fixed.

19. The drive train of claim 16, wherein the second planet carrier (34) is permanently connected to the third ring gear (46) for conjoint rotation.

20. The drive train of claim 16, further comprising a second electric machine (EM2) with a second motor shaft (W2) and a connecting gearing (60) with an input shaft and with an output shaft, wherein the second motor shaft (W2) is permanently connected to the input shaft for conjoint rotation, and wherein the output shaft is mechanically operatively connectable to the driven shaft (12).

21. The drive train of claim 20, wherein the output shaft is connectable to the driven shaft (12) for conjoint rotation.

22. The drive train of claim 20, wherein the output shaft is connectable to the third planet carrier (44) for conjoint rotation.

23. The drive train of claim 20, wherein the connecting gearing (60) further comprises a fourth planetary gear set (70) with a fourth sun gear (72), a fourth planet carrier (74), and a fourth ring gear (76), and a transmission gearing (62), wherein the fourth sun gear (72) is permanently connected to the second motor shaft (W2) for conjoint rotation, wherein the fourth planet carrier (74) is mechanically operatively connected to the output shaft of the connecting gearing (60), and wherein the fourth ring gear (76) is rotationally fixed.

24. The drive train of claim 16, further comprising a first freewheel unit (F1), wherein the pedal crankshaft (10) is mechanically operatively connectable to the driven shaft (12) by the first freewheel unit (F1).

25. The drive train of claim 24, wherein the pedal crankshaft (10) is connectable to the third planet carrier (44) for conjoint rotation by the first freewheel unit (F1), the third ring gear (46) is permanently connected to the driven shaft (12) for conjoint rotation, and the first planet carrier (24) is permanently connected to the third sun gear (42) for conjoint rotation.

26. The drive train of claim 24, wherein the third ring gear (46) is connectable to the driven shaft (12) for conjoint rotation by the first freewheel unit (F1), the pedal crankshaft (10) is permanently connected to the third planet carrier (44) for conjoint rotation, and the first planet carrier (24) is permanently connected to the third sun gear (42) for conjoint rotation.

27. The drive train of claim 24, wherein the first planet carrier (24) is connectable to the third sun gear (42) by the first freewheel unit (F1), the pedal crankshaft (10) is permanently connected to the third planet carrier (44) for conjoint rotation, and the third ring gear (46) is permanently connected to the driven shaft (12) for conjoint rotation.

28. The drive train of claim 16, further comprising a second freewheel unit (F2), wherein the second freewheel unit (F2) is configured for blocking a rotation of the first motor shaft (W1) in one direction of rotation.

29. The drive train of claim 28, wherein the first motor shaft (W1) is rotationally fixable by the second freewheel unit (F2).

30. The drive train of claim 29, wherein a rotary element of the first planetary gear set (20) is rotationally fixable by the second freewheel unit (F2).
